(19) United States
(12) Patent Application Publication
(10) Pub. No.: US 2002/0128348 A1
(43) Pub. Date: Sep. 12, 2002

(54) Inkjet ink microcapsules having colored shells

(76) Inventor: Donald J. Palmer, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/803,177

(22) Filed: Mar. 7, 2001

(51) Int. Cl. C09D 5/00; C09D 11/00; C08G 2/00

(52) U.S. Cl. 523/160; 523/161; 523/201

(57) ABSTRACT

Microcapsules for an inkjet ink composition are provided with a colored shell that, upon rupture, substantially determines the color of the image produced by such microcapsules.

### BACKGROUND OF THE INVENTION

1. Technical Field

This invention generally relates to inkjet inks. It is particularly concerned with the use of inkjet inks that further comprise microencapsulated particles.

2. Description of Related Art

Most inkjet inks that contain microcapsule components are primarily comprised of a liquid vehicle or carrier for the microcapsules and the microcapsules themselves. The microcapsules are typically comprised of a polymeric shell that surrounds a core material that includes: (1) one or more polymer binder compositions, (2) one or more colorants (pigments, dyes or mixtures thereof) and (3) one or more auxiliary ingredients.

The methods by which such a microcapsule's core materials have been microencapsulated by a shell material vary considerably. For example, so-called “interfacial polymerization” methods are described in U.S. Pat. Nos. 3,577,515, and 3,429,827. So-called “inner polymerization” methods are described in U.S. Pat. Nos. 3,660,304, 3,726,804, 3,796,669 and 2,969,330. “Phase separation” methods are described in U.S. Pat. Nos. 2,800,457, 2,800,458, 3,041,289, and 3,205,175. Various “outer polymerization” methods are described in U.S. Pat. Nos. 4,087,376, 4,089,802, 3,100,103, and shell have created certain problems that have not been completely recognized and/or solved. For example, the fix level of a developed inkjet ink image made from encapsulated particles by heat and pressure fixing methods is generally dependent on the rate of, and extent of, diffusion of the adhesive/colorant components that are “squeezed out” of a ruptured microcapsule. These adhesive/colorant components have two major functions. The adhesive component must fix to the paper (or other substrate) and the colorant component must present itself to the view of a human observer. To some degree, low initial fix levels of microencapsulated inkjet inks follow from the fact that some of the core components are primarily concerned with carrying out chemical reactions involving the dyes and/or pigments released when the shell is ruptured—rather than the chemical and/or physical reactions needed to fix the ruptured microcapsule to the substrate. That is to say that in order to present itself to human view, the colorant in many microcapsule-employing inkjet ink systems, also must chemically react with a core ingredient (e.g., an adhesive resin or other auxiliary core compound or composition) under the exposed (i.e., ruptured shell) conditions. These color-producing chemical reactions may inhibit the physico-chemical reactions needed to fix the adhesive to the print medium.

### SUMMARY OF THE INVENTION

In response to the foregoing problems, applicant has developed microencapsulated particles that eliminate the need for chemical reactions between a dye or pigment (or any other ingredient of the microcapsule) in order to produce a desired color in an inkjet image. This is done through use of inkjet compositions that include microcapsules having colored shells that provide improved inkjet image qualities. These improved image qualities follow from at least two aspects of the present invention. The first is that the color of the shells of applicant's microencapsulated particles substantially produces the color of the image produced by the inkjet printing process. The second aspect is that the microcapsule's core components are released from those coloring-producing duties called for in those prior art inkjet ink compositions that include microencapsulated particles. Hence, the core components can be more specifically selected to carry out their ink/media fixing duties. This is to say that a higher initial fixing of applicant's ruptured microcapsules to a print media such as paper can be accomplished by virtue of the fact that the core components of applicant's microcapsules are primarily devoted to fixing the ruptured microcapsule to the paper—as opposed to also being devoted to (1) carrying out color-producing chemical reactions of core-based colorants and/or (2) preventing certain color degrading reactions between the colorant and the media (e.g., paper) upon which the ruptured microcapsule is placed. These two image-improving attributes are made possible by virtue of the fact that applicant places the color-imparting components of an inkjet ink microcapsule in its shell material rather than (1) in its core components, or (2) on the surface of the shell material as per the teachings of the '211 patent and the '144 patent.

In some of the more preferred embodiments of this invention, a major portion of the colorant in the inkjet ink composition will be in the shell material of the microcapsule. That is to say that a relatively small portion (e.g., less than 10%) of the colorant material in these inkjet ink compositions will be in the carrier or vehicle (water, alcohol, etc.) component of the ink composition. Conversely, a relatively large proportion (more than 90%) of the colorant will be in the shell material of the microcapsules. Since applicant's shell materials do not need to enter into any color-producing chemical reactions, the color of the shell material will for all practical purposes “be” the color of the image produced by the inkjet printing process. In other words, when a shell of applicant's microencapsulated particles is ruptured, the core resin ingredient(s) is (are) primarily concerned with fixing the ruptured shell (of an already predetermined color) to the paper or other substrate.

For the purposes of this patent disclosure, the term “colored shell” can be taken to mean that one or more dyes and/or pigments are incorporated into the shell material so that, for the most part, the shell is the material that substantially imparts a given color to an image produced by that inkjet ink. Thus, the color of the image can be more closely controlled since the colorant used in making the shell material of the microcapsule need not involve itself in a color-producing chemical reaction when the shell is ruptured. Nor is the colorant in the shell material of applicant's ink microcapsules degraded by any chemical and/or physical reactions between the print media (e.g., a sheet of paper) and the adhesive component of the microcapsule's core composition.

The microcapsules of the present inkjet inks can be ruptured by microwave energy, pressure, heat, pH, light, radiation, ultrasound and combinations thereof, in order to release the core material, e.g., the binder, magnetic particles, etc. within the microcapsule shell on to a substrate such as a piece of paper. Preferably the core material is a liquid or semi-liquid binder material that is released on to the paper when the shell is ruptured. In effect, the hard, colored shells are “glued down” to the substrate by the binder material when applicant's ink microcapsules are ruptured.

### BRIEF DESCRIPTION OF THE DRAWINGS

FIG. 1 is a cross sectional view of a microcapsule made according to a first prior art method.

FIG. 2 is a cross sectional view depicting the results of rupturing the microcapsule shown in FIG. 1.

FIG. 3 is a perspective view of the results of rupturing the microcapsule shown in FIG. 1.

FIG. 4 is a cross sectional view of a microcapsule made according to a second prior art method.

FIG. 5 is a cross sectional view depicting the results of rupturing the microcapsule shown in FIG. 4.

FIG. 6 is a perspective view of the results of rupturing the microcapsule shown in FIG. 4.

FIG. 7 depicts a cross sectional view of an embodiment of the present invention wherein a microcapsule of an inkjet ink composition is comprised of a rupturable, colored shell that encapsulates a binder material.

FIG. 8 depicts a cross sectional view of the microcapsule of FIG. 7 upon being ruptured and associated with a substrate material such as a sheet of paper.

FIG. 9 depicts a perspective view of the results of rupturing the microcapsule shown in FIG. 7.

FIG. 10 depicts a cross sectional view of another embodiment of the present invention wherein a microcapsule of an inkjet ink composition is comprised of a rupturable, colored shell that also contains auxiliary ingredients.

FIG. 11 is a cross sectional view of the microcapsule of FIG. 10 upon being ruptured.

FIG. 12 is a perspective view of the results of rupturing the microcapsule shown in FIG. 10.

### DETAILED DESCRIPTION OF THE INVENTION

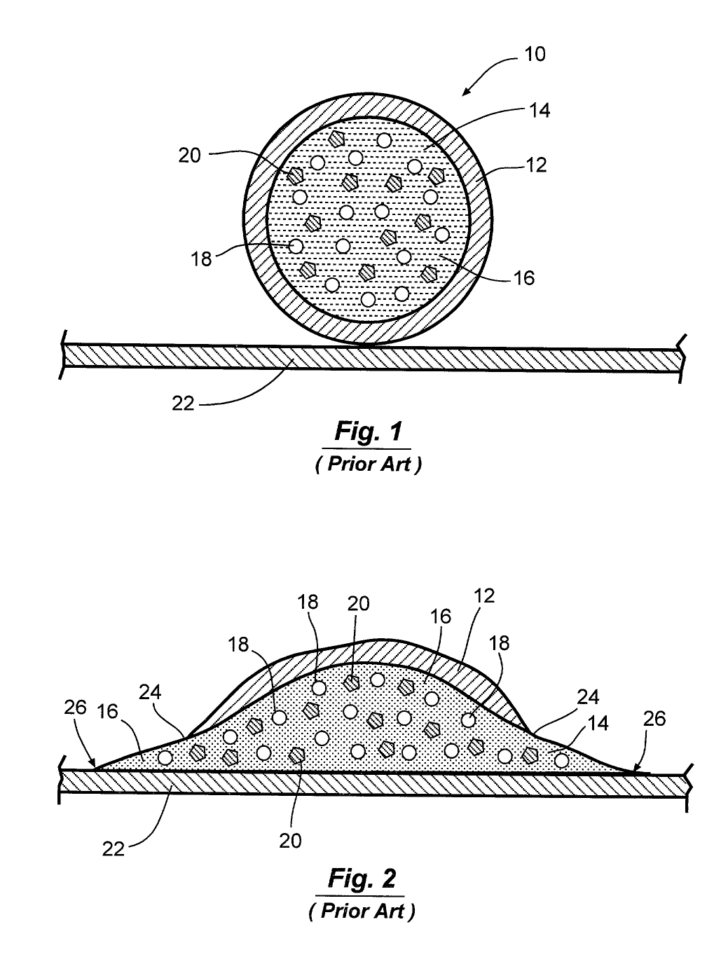

FIG. 1 depicts, in cross section, a microcapsule 10 used in certain prior art inkjet ink compositions. This microcapsule 10 is made according to a prior art concept wherein a shell 12 encapsulates a core composition 14. The core composition 14 is, in turn, comprised of one or more adhesive materials 16, one or more color imparting dye and/or pigment components 18 and one or more accessory compounds or compositions 20 often used in the formulation of inkjet inks. This core composition 14 is normally in a liquid or semi-liquid state when the shell 12 is ruptured. That is to say that the core or it may be made to be a liquid by the pressure, heat, microwave, ultrasound, pH change, etc. used to rupture the shell. Be that as it may, the microcapsule 10 is shown resting on a print media substrate 22 such as a sheet of paper.

In general terms, the purpose of the shell 12 is to contain the core composition 14 until such time as its ingredients are deployed and affixed to a print media substrate in an inkjet printing process. The function of the adhesive material 16 is to fix a ruptured shell 12 and its core composition 14 to the substrate 22. Again, the core composition 14 includes a colorant 18 such as a dye or a pigment or both. Thus, the colorant 18 is “released” by rupture of the shell 12. As was previously noted, many inkjet printing processes that employ carrier fluids (e.g., water, alcohol, etc.) in which microcapsules are suspended also involve carrying out desired chemical reactions between the dye or pigment and the adhesive material (or other ingredients mixed with the core material 14) upon rupture of the shell 12. Such inkjet printing process also often involve undesired chemical reactions between the dye or pigments, the adhesive material and/or the paper upon which the adhesive and dye components are placed by rupture of the shell. Again, the core material 14 of most microcapsules for inkjet inks also includes a wide variety of auxiliary ingredients 20. The function of some of these auxiliary ingredients 20 may be to enter into color-producing chemical reactions.

FIG. 2 depicts the prior art inkjet ink microcapsule of FIG. 1 in a ruptured state. This depiction is highly generalized and highly idealized. Again, such a ruptured state can be produced by pressure, heat, microwave energy, pH, light, radiation, ultrasound and combinations thereof. In this ruptured state, the liquid or semi-liquid contents of the core composition 14 of the ruptured microcapsule have spread out over a dot-like region of the substrate 22 and have begun the process of adhering to it. In this prior art inkjet printing process the liquid or semi-liquid contents of the microcapsule's core generally spread out beyond the edge 24 of the remains of, or unbroken parts of, the shell 12. Again, the contents of the core composition 14 include the color imparting material 18 (dye and/or pigment). Thus, only the contents of the core composition 14 that extend beyond the edge region 24 of any unbroken parts of the shell 12 to the outer perimeter 26 of the contents of the ruptured cell will impart a desired color to the ruptured shell system. In other words, only the dye or pigments in the core composition 14 that are released beyond the edge region 24 will impart a desired color to the overall ruptured cell system. To the extent that the dye or pigments enter into undesired chemical reactions with the other components of the core composition (under the ruptured cell conditions), or with the paper 22, the color quality of the core composition 14 is diminished.

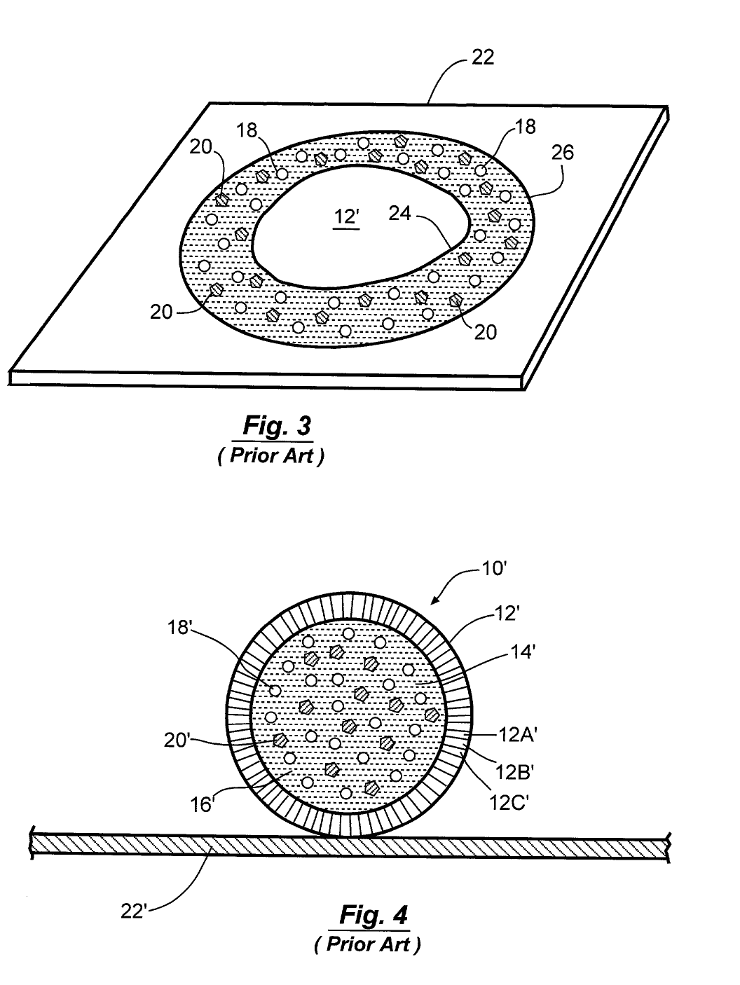

FIG. 3 is a perspective view of the ruptured shell system depicted in FIG. 2. It shows that the edge region 24 of the unbroken portion of the shell 12 encircled by a portion of the core composition 14 of the shell 12 shown in FIG. 1. This portion of the core composition extends from the edge region 24 of the shell 12 to the perimeter 26 of the ruptured shell system. It contains the color creating materials 18 of the core composition 14. It is this exposed portion of the core composition 14 that imparts the desired color to the overall mound of materials that originally comprised the microcapsule. Thus, in this prior art system, the presence of the shell 12 on the upper center portion of the core composition 14 can detract from the color quality of the ruptured microcapsule depicted in FIG. 3. Moreover, the core composition materials 14 that lie between the ruptured shell's edge region 24 and the outer parameter 26 of the shell system are usually involved in desired (and undesired) chemical reactions that are difficult to control owing to changes in such variables as ambient temperature and relative humidity, moisture content of the paper (which effects its electrical resistivity) and the temperatures at which the inkjet printer operates as it processes a batch of paper.

FIG. 4 depicts, in cross section, an inkjet ink microcapsule 10′ made according to another prior art concept wherein a shell material 12′ again encapsulates a core composition 14′. The shell material is depicted as being comprised of subunits 12A′, 12B′, 12C′, etc. It should be understood that this depiction is an abstraction of a chemical concept rather than a physical one. That is to say that these subunits 12A′, 12B′, 12C′, etc. can be thought of as being chemical ingredients rather than an array of distinct physical particles that comprise the shell 12′. These chemical ingredients 12A′, 12B′, 12C′, etc. from which the shell 12′ is made are shown in this way to illustrate the fact that these chemical ingredients enter into chemical reactions with color producing ingredients 18′ (e.g., dyes, pigments, etc.) in the core composition 14′ when the shell 12′ is ruptured. In any case, the core composition 14′ is again comprised of an adhesive material 16′, color imparting dye and/or pigment components 18′ and one or more auxiliary compounds and/or compositions 20′. The microcapsule 10′ is again shown resting on a substrate 22′ such as a sheet of paper.

Thus, in this system, the shell 12′ once again contains the core composition 14′, but in this system the shell 12′ is made of chemical components 12A′, 12B′, 12C′ that enter into chemical reactions with one or more core composition components. That is to say that the shell materials 12A′, 12B′, 12C′, etc. are “used up” in chemical reactions with a core composition ingredient when the shell 12′—is broken. Again, one such core composition 14′ ingredient can be a color imparting material 18′ such as a dye or a pigment or both. The core composition 14′ may also includes other components (polymers) that enter into a chemical reaction with the chemicals 12A′, 12B′, 12C′ from which the shell 12′ is made. Thus, the shell ingredients are used up in a chemical reaction with certain core composition ingredient(s) when the shell is exposed to the energy (e.g., heat, pressure, microwave, ultrasound, etc.) used to rupture the shell.

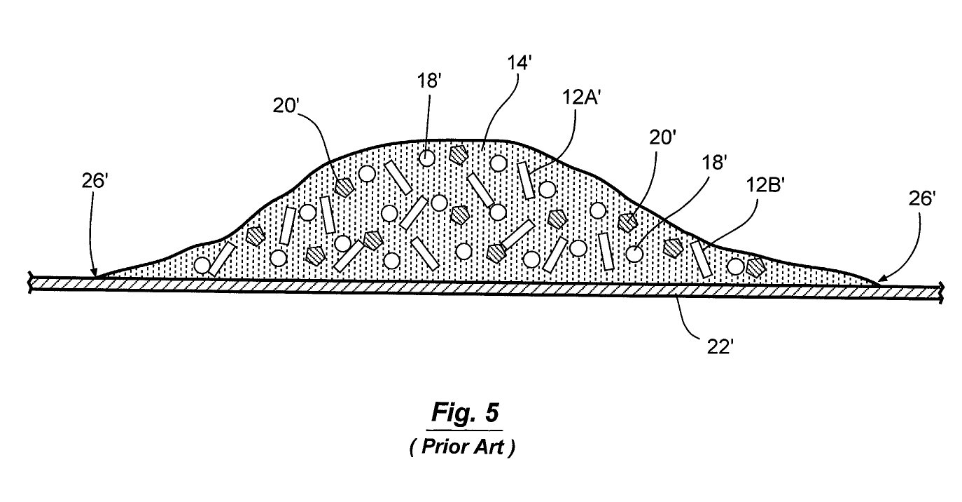

FIG. 5 depicts the microcapsule of FIG. 4 in a ruptured state. In this ruptured state, the contents of the core have spread out over a portion of the substrate 22′ and have begun the process of adhering to it. In this system the liquid contents of the core composition 14′ have spread out to the edge 26′ of the mound of material produced by the shell rupture. The contents of the core composition can be thought of as having been chemically reacted with the shell-forming chemicals 12A′, 12B′, 12C′. Hence these shell-forming chemical components are used up and become another component of the overall mound of the core materials. The contents of the core composition also includes the color imparting material 18′ (dye or pigment). Thus, the entire contents of the ruptured core (the mound depicted in FIG. 5) give the resulting mound of material a substantial part of the color of the image produced by such inkjet inks. In this prior art system, it is again the case that, to the degree that the dye and/or pigment components 18′ (1) fail to react with the core components in an intended way, (2) fail to react with the shell-forming chemicals 12A′, 12B′, 12C′ an intended way and (3) do react with the paper substrate in ways that are not desired, the quality of the image made from such microcapsules is diminished.

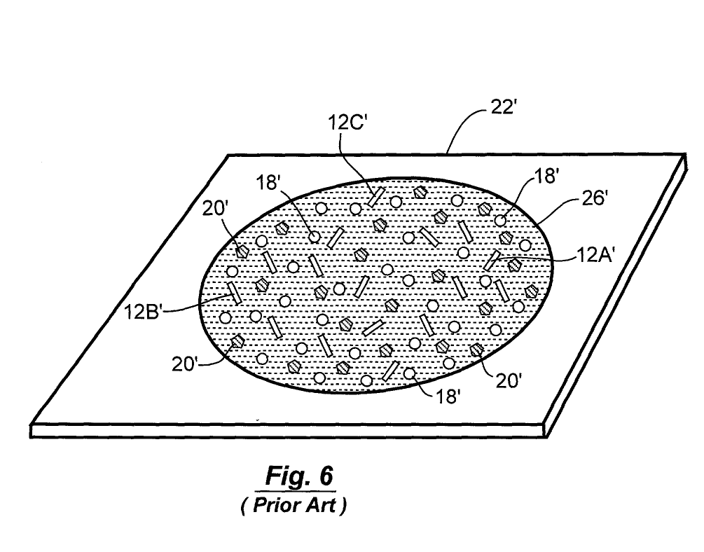

FIG. 6 is a perspective view of the ruptured shell depicted in FIG. 5. It shows that contents of the shell shown in FIG. 5 spread over the print media. The ingredients that originally formed the shell are, to some degree, used up in chemical reactions that occur once the shell is broken open. That is to say there are no actual shell fragments such as that shown in item 12′ in FIGS. 4 and 5. Rather, the same mixed ingredient system extends to the perimeter 26′ of mound. This mound of material also contains the color creating contents 18′ of the core material 14′. Thus, the presence of the shell 12′ on the center portion of the core material shown in FIGS. 4 and 5 is eliminated. But the chemical reaction between the shell ingredients and the core ingredients, and especially the dye and/or pigment ingredients, can detract from the color quality of the ruptured microcapsule depicted in FIG. 6.

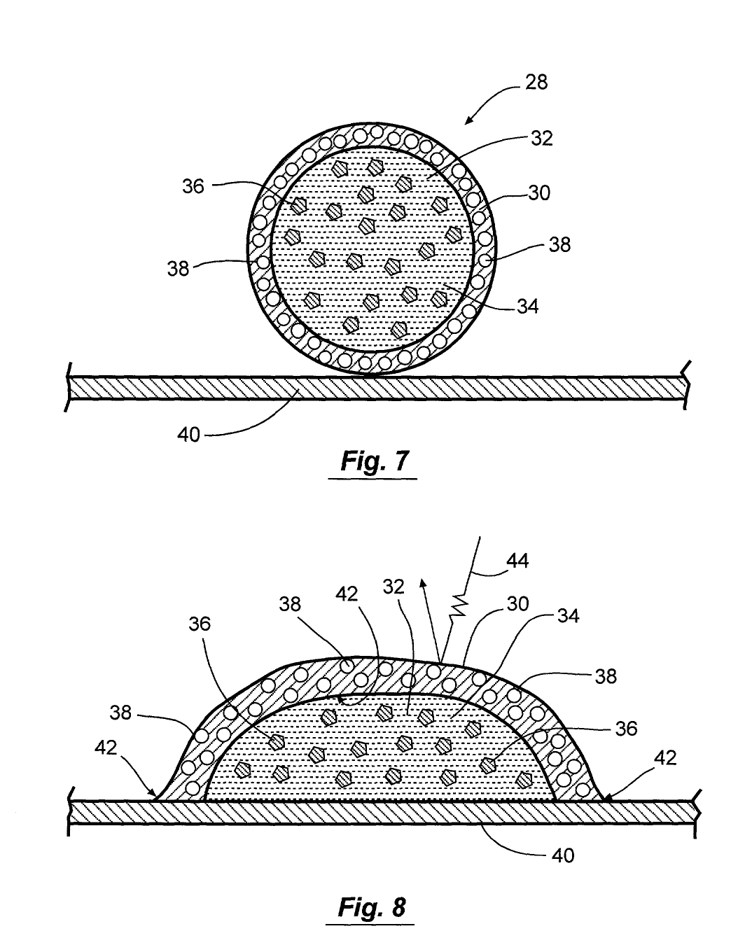

FIG. 7 depicts a side cross-sectional view of a microcapsule 28 component of an inkjet ink composition made according to the teachings of this patent disclosure. Such a composition will generally comprise a liquid carrier (water, alcohol, ketone, paraffinic oil, etc.) and the microcapsules suspended in that carrier. In some of the more preferred embodiments of this invention the microcapsules will comprise from about 5 to about 60 weight percent of the ink composition. Thus, the liquid carrier (e.g., water, alcohol, ketone, paraffinic oil, etc.) will preferably comprise from about 2 weight percent to about 25 weight percent of the ink composition. The liquid carrier will therefore preferably comprise from about 98 to about 2 weight percent of the ink composition. The liquid carrier may have various other ingredients dissolved and/or suspended in it as well. Regardless of its proportions, any given microcapsule 28 will have a shell 30 that contains a core composition 32. This core composition 32 is comprised of a binder material 34 and one or more auxiliary ingredients 36 that are commonly used in inkjet ink compositions. This microcapsule 28 differs from those prior art microcapsules depicted in FIGS. 1 and 4 in that the microcapsule's colorant component(s) 38 (dye, pigment) of the present invention is (are) in the shell 30 rather than in the core composition 32. It also should be emphasized that this depiction also is an abstraction of the presence of certain chemical ingredients. The colorant 38 imparts a color to the material that comprises the shell 30. That is to say that the colorant materials do not exist in the form of the visibly distinct particles 38 shown in FIG. 7, but rather are a chemical component of a compound or composition (e.g., a polymer/dye compound or composition) that forms the shell 30. FIG. 7 uses this physical depiction of a colorant 38 ingredient in the shell 30 in order to emphasize that the colorant(s) 38 of applicant's toner microcapsule 28 are in its shell 30 material and not its core 32 as it was in the previously discussed prior art systems.

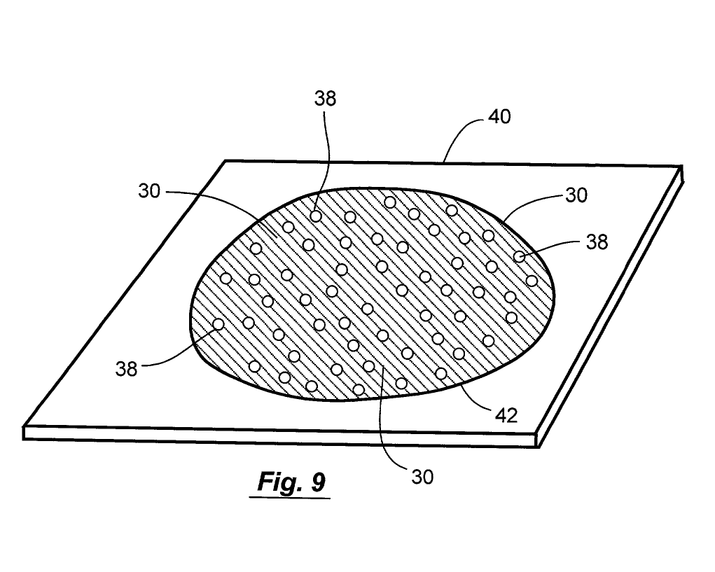

FIG. 8 depicts the results of rupturing the microcapsule 28 shown in FIG. 7. It shows a ruptured shell 30 (having a highly idealized hemispherical configuration) overlying a mound of the core composition 32. The core composition 32 includes a binder material 34 that, upon rupture of the shell, adheres to the substrate 40 and to the underside of the ruptured shell 30. The ruptured shell 30 is affixed to the substrate 40. It might also be noted that the core composition 32 does not extend beyond the edge 42 of the shell. Thus, the color of the ruptured shell/core contents is determined by the color of the shell 30 and not by the color of the core content materials 32. This circumstance is depicted by the reflection and/or absorption of a light ray 44 off of the ruptured shell 30. Thus, the color of the shell material determines the color of the visual impression received from the shell/core content system.

FIG. 9 is a perspective view of the ruptured shell 30 shown in

FIG. 8. It too illustrates that the core material does not extend beyond the perimeter 42 of the shell 30.

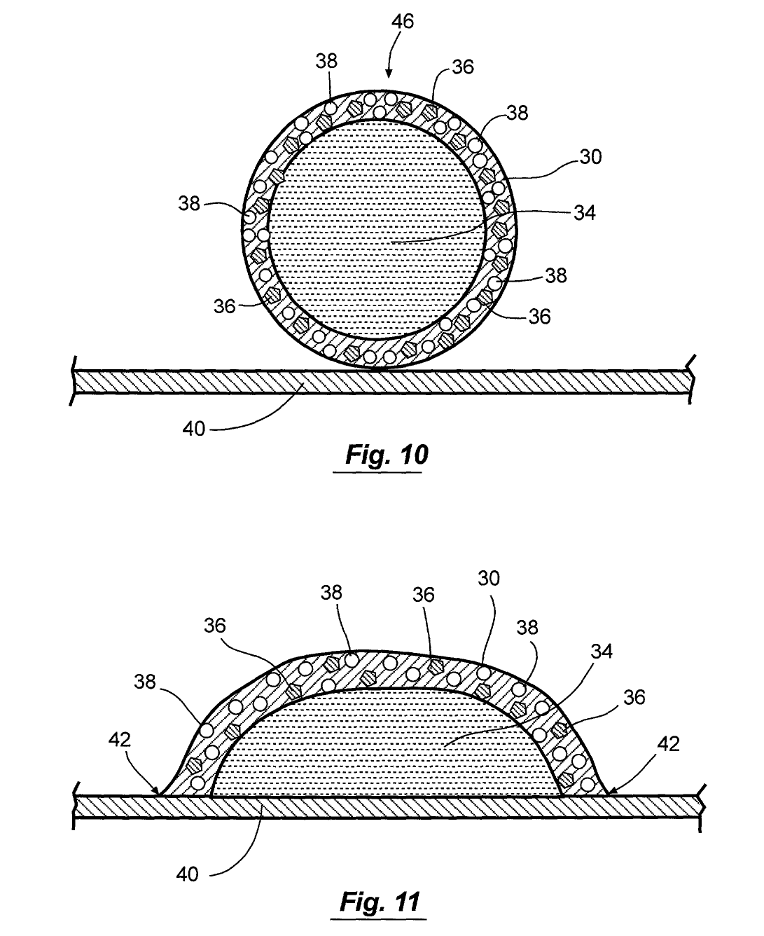

FIG. 10 depicts a cross sectional view of another embodiment of the present invention wherein a microcapsule of a rupturable, colored shell that also contains auxiliary ingredients.

FIG. 11 is a cross sectional view of the microcapsule of FIG. 10 upon being ruptured.

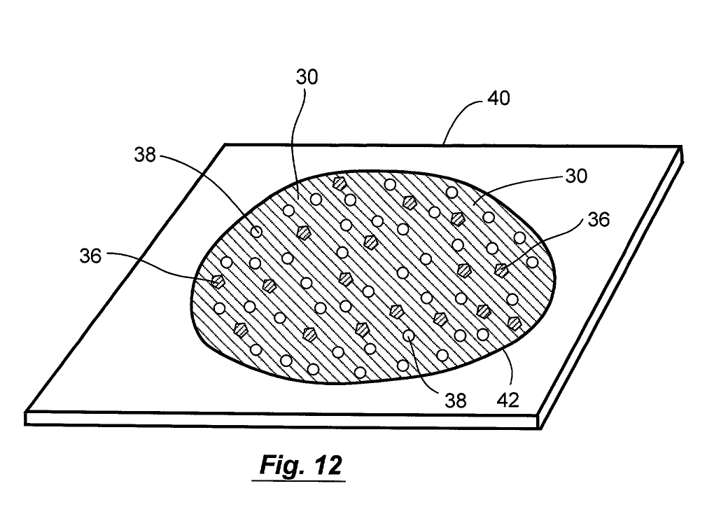

FIG. 12 is a perspective view of the results of rupturing the microcapsule shown in FIG. 10.

### Ingredients

### Shell Ingredients

The shell component(s) of the microcapsules of this patent disclosure will normally be polymers. Polyester, polyamide, polystyrene, polysulfonamide, polysulfonate, polycarbonate, polyether, polyethylene, polyurea, polyurethane, polythioyrethane, polythiourea, amino resin, and copolymers such as poly(styrene-methacrylate) and poly(styrene-acrylate) are especially useful.

The shell can be composed substantially of a single or a complex layer. For instance, the shell can comprise two or more polymers selected from the group consisting of polyurethane, polyurea and polyamide. For the purposes of this patent disclosure, the polyurethane or polyurea polymers will preferably be produced by a polycondensation reaction between polyisocyanate and one or more of the counterpart compounds such as polyol, polythiol, water, polyamine and piperazine. Accordingly, the term “polyurethane” can be taken to mean either a simple polyurethane comprising substantially the urethane bondings only, or a polymer comprising the urethane bondings and a relatively small number of urea bondings. The term “polyurea” can be taken to mean either a simple polyurea comprising substantially the urea bondings only, or a polymer comprising the urea bondings and a relatively small number of urethane bondings.

The shell polymer will preferably comprise from about 5 to about 40 percent by weight of applicant's inkjet ink compositions. During an interfacial polymerization to form the shell, the temperature will preferably be maintained at from about 20° C. to about 60° C. Generally speaking the reaction time will be from about 5 minutes to about 5 hours. The resulting shell have an effective thickness of, for example, less than about 5 microns. Specific examples of shells include those comprised of the interfacial polycondensation reaction of a first polyisocyanate component and a second amine component, and wherein said toner includes an electroconductive material obtained from a water based dispersion of said material in a polymeric binder.

### Binder Materials

The core material of the microcapsules of this invention will comprise at least one binder material (adhesive material) for fixing a ruptured shell to the surface of a support medium such as paper. The binder material is preferably a liquid or semi-liquid resin upon rupture of the shell. Useful resins for the practice of this invention will include natural resins such as rosin (gum rosin, wood rosin, tall oil rosin), shellac, copal, dammar, gilsonite and zein; semi-synthetic resins such as hardened rosin, ester gum and other rosin esters, maleic acid resin, fumaric acid resin, dimmer rosin, polymer rosin, rosin-modified phenol resin, methyl cellulose, ethyl cellulose, hydroxyethyl cellulose, hydroxypropyl cellulose, ethyl hydroxyethyl cellulose, carboxymethyl cellulose, cellulose acetate propionate, cellulose acetate butyrate and nitrocellulose; synthetic resins such as phenolic resin, xylenic resin, urea resin, melamine resin, ketone resin, coumarone-indene resin, petroleum resin, terpene resin, cyclized rubber, rubber chloride, alkyd resin, polyamide rein, acrylic resin, polyvinyl chloride, vinyl chloride-vinyl acetate copolymer, polyvinyl acetate, ethylene-maleic anhydride copolymer, styrene-maleic anhydride copolymer, methyl vinyl ether-maleic anhydride copolymer, isobutylene-maleic anhydride copolymer, polyvinyl alcohol, modified polyvinyl alcohol, polyvinyl butyral (butyral resin), polyvinyl pyrrolidone, chlorinated polypropylene, styrene resin, epoxy resin and polyurethane.

Such resins also may include oligomers or prepolymers having an ethylenically unsaturated bond such as polyethylene glycol diacrylate, propylene glycol dimethacrylate, pentaerythritol triacrylate, trimethylolpropane diacrylate, trimethylolpropane triacrylate, pentaerythritol tetraacrylate, hexanediol diacrylate, 1,2-butanediol diacrylate, adduct of epoxy resin and acrylic acid, reaction product of acrylic acid, methacrylic acid and pentaerythritol, condensed product of maleic acid, diethylene glycol and acrylic acid, methyl methacrylate, butyl methacrylate and styrene.

Binder resins that are especially useful in the practice of this invention will include those having a polymeric component which is solid at about 15° C. and will melt below about 160° C. These binder resins will preferably comprise from about 30 to about 60 weight percent of the microcapsule.

### Auxiliary Ingredients

Those skilled in this art will appreciate that inks in general, and microcapsule-based inkjet inks in particular, are complex compositions. For example, aside from their adhesive and colorant ingredients, an ink microcapsule may contain a wide variety of auxiliary ingredients such as surfactants, ultraviolet ray absorbing agents, antioxidants, fluorescent dyes, photopolymerization initiators, waxes, driers, viscosity-increasing agent, gelation agents, plasticizers, desensitizers, election donating organic chromogenic materials, electron accepting reactant materials, ligand compounds, organic metal salts, fluorescent compounds and phosphorescent compounds. For the sake of simplicity any or all of these auxiliary ingredients are designated by as item 20 in FIG. 1 and as item 36 in FIG. 7.

### Colorants

Various known dyes and/or pigments can be incorporated into the shell-forming materials. Primary colored pigments, that is cyan, magenta, or yellow pigments, can also be selected for the shell compositions of the present invention. Examples of magenta materials that may be selected as pigments include, for example, 2,9-dimethyl-substituted quinacridone and anthraquinone dye. Illustrative examples of cyan materials that may be used as pigments include copper tetra-4(octadecyl sulfonamido) phthalyocyanine, x-copper phthalocyanine pigment. Examples of yellow pigments that may be selected are diarylide yellow 3,3-dichlorobenzidene acetoacetanilides, a monoazo pigment. The aforementioned pigments can be incorporated into the shell of the microcapsules of the present invention in various effective amounts. In one embodiment, the pigment particles are present in the ink composition in an amount of from about 2 percent by weight to about 65 percent by weight calculated on the weight of the ink composition.

### Method of Making

The microcapsules used in the inkjet inks of the present invention can be prepared by a number of different processes. One of the main objects of such processes is to provide the shell of the microcapsules with a desired color. Thus, processes of this patent disclosure differ from those prior art processes wherein the dyes or pigments are among the materials that are encapsulated by the encapsulation process. Applicant's microcapsules can, for example, be made from interfacial polycondensations similar to those used to make prior art microcapsules. Applicant's versions of such processes, however, generally begin by thoroughly mixing or blending a mixture of core binder monomer or monomers, a free radical initiator, a magnetic material, and a polyisocyanate or polyisocyanates. The aforementioned ingredients are then blended by high shear blending into a system of stabilized microdroplets of specific droplet size and size distribution in an aqueous medium containing a suitable stabilizer or emulsifying agents. The diameter of the average microdroplet can be desirably adjusted to be from about 3 microns to about 30 microns. This dispersion is then subjected to a shell forming interfacial polycondensation by adding a colorant-containing polyol or polyols. Such polyols are preferably selected from low molecular weight carbohydrates such as monosaccharides or disaccharides. Thereafter the core binder forming free radical polymerization is initiated within the newly formed microcapsules. The shell forming interfacial polycondensation is generally executed at ambient temperature. Elevated temperatures also may be employed depending on the nature and functionality of the shell components used.

According to another embodiment of the present invention the microcapsules of applicant's inkjet ink compositions are prepared by dispersing core polymers into colored preheated shell wall-forming materials. In addition to its dye and/or pigment ingredients, the shell wall-forming material preferably will contain an oil, preferably a soybean oil, a binder resin, preferably a maleic modified rosin ester, a thixotropic agent, preferably an oxidized homopolymer polyethylene gel and an ionomer, preferably an ethylene acrylic acid ionomer, preferably sodium ionomer.

The colored shell wall-forming materials are then heated to a temperature just above their softening point (i.e., 130°-160° C.). The heating is accompanied with constant mixing until all the ingredients are melted and dissolved in the carrier, such as soybean oil. At this stage the core-forming particles, i.e., the capsules core materials, are added portion-wise to the hot shell wall materials while maintaining the constant stirring. After the completion of the addition of the particles, the mixture is allowed to be mixed until a homogeneous, uniform dispersion of the iron oxide pigments in the host hot shell wall forming materials is achieved. Finally the mixture is allowed to cool to the room temperature. Upon cooling the system, the colored shell wall materials solidify and encapsulate the particles with a (hydrophobic) shell. The microcapsules produced by this process generally produce a colored shell of 0.03 to 1.0 micron in thickness and an average particle size of 5 to 18 microns. Of these methods the interfacial polymerization method and the inner polymerization method are somewhat preferred.

The ink compositions of this patent disclosure also may contain various auxiliary agents such as capsule-protecting agents, surfactants, ultraviolet ray absorbing agents, antioxidants, photopolymerization initiators, waxes, driers, viscosity-increasing agent, gelation agents, plasticizers, desensitizers, ligand compounds and organic metal salts.

Although the preceding disclosure sets forth a number of embodiments of the present invention, those skilled in this art will however appreciate that other embodiments, not precisely set forth, could be practiced under the teachings of the present invention. Therefore, the scope of this invention is limited only by the scope of the following claims.

I claim:

1. A microcapsule for an inkjet ink, said microcapsule comprising:
(1) a colored, rupturable, shell whose color substantially defines a color of a portion of an image formed from said microcapsule, and
(2) a core composition that is encapsulated by the colored, rupturable shell and which includes an adhesive that serves to affix a ruptured form of the microcapsule to a print medium.

2. The microcapsule of claim 1 wherein the adhesive is a polymer based adhesive.

3. The microcapsule of claim 1 wherein the colored, rupturable, shell is colored through use of a dye in the microcapsule's shell-forming ingredients.

4. The microcapsule of claim 1 wherein the colored, rupturable, shell is colored through use of a pigment in the microcapsule's shell-forming ingredients.

5. An inkjet ink comprising:
(1) a liquid vehicle in which a plurality of microcapsules are suspended;
(2) a plurality of microcapsules wherein individual microcapsules of the plurality of microcapsules are comprised of a colored, rupturable, shell whose color substantially defines the color of a portion of an image formed from an individual microcapsule; and
(3) a core composition that is encapsulated by the colored, rupturable shell and which includes an adhesive that serves to affix a ruptured form of the microcapsule to a print medium.

6. The inkjet ink of claim 5 wherein the adhesive is a polymer based adhesive.

7. The inkjet ink of claim 5 wherein the colored, rupturable, shell is colored through use of a dye in the microcapsules' shell-forming ingredients.

8. The inkjet ink of claim 5 wherein the colored, rupturable, shell is colored through use of a pigment in the microcapsules' shell-forming ingredients.

9. The inkjet ink of claim 5 wherein the microcapsules comprise from about 2 to about 25 weight percent of said ink.

10. The inkjet ink of claim 5 wherein the shell is a polymer material.

11. An inkjet printing system comprising:
an inkjet printing device;
a shell rupturing device for rupturing the shell of microcapsules;
a liquid vehicle in which a plurality of microcapsules are suspended,
a plurality of microcapsules wherein individual microcapsules of the plurality of microcapsules are comprised of:
a colored, rupturable, shell whose color substantially defines the color of an image formed from the plurality of microcapsules, and
a core composition that is encapsulated by the colored, rupturable shell and which includes an adhesive that serves to affix a ruptured form of the microcapsule to a print medium.

12. The inkjet printing system of claim 11 wherein the adhesive is a polymer based adhesive.

13. The inkjet printing system of claim 11 wherein the colored, rupturable, shell is colored through use of a dye in the microcapsules' shell-forming ingredients.

14. The inkjet printing system of claim 11 wherein the colored, rupturable, shell is colored through use a pigment in the microcapsules' shell-forming ingredients.

15. The inkjet printing system of claim 11 wherein the shell rupturing device employs microwave energy to rupture the shell.

16. The inkjet printing system of claim 11 wherein the shell rupturing device employs heat to rupture the shell.

17. The inkjet printing system of claim 11 wherein the shell rupturing device employs pressure to rupture the shell.

18. The inkjet printing system of claim 11 wherein the microcapsules further comprise an auxiliary ingredient.

19. The inkjet printing system of claim 11 wherein the microcapsules comprise from about 2 to about 25 weight percent of said ink.

20. The inkjet printing system of claim 11 wherein the shell is a dye colored polymer material.
